(19) United States
(12) Patent Application Publication
(10) Pub. No.: US 2007/0226261 A1
(43) Pub. Date: Sep. 27, 2007

(54) Information processing device, selection item priority giving program and selection item priority giving method

(75) Inventor: Tomoya Urita, Echizen-city (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: ORION ELECTRIC CO., LTD., Echizen-city (JP)

(21) Appl. No.: 11/715,444

(22) Filed: Mar. 8, 2007

(30) Foreign Application Priority Data
Mar. 27, 2006 (JP) 2006-085015

(51) Int. Cl. G06F 7/00

(52) U.S. Cl. 707/104.1

(57) ABSTRACT

The invention provides an information processing device which allows a user's recent usage to be reflected while leaving the user's usage history in the past with an item selection function having a simplified operation for selecting a selection item in terms of a method of managing selection history of the selection item. When there is a request for display of a menu screen (step 301), the selection item with the most usage history is obtained and automatically selected (a setup item screen is displayed) (steps 302 to 305), and the usage history of the automatically selected item is subtracted (step 309) in the case where it is determined that the automatically selected item has not been used (step 307) so as to reflect the user's recent usage (a fact that it has not been used) on the history.

The present application is based on and claims priority of Japanese patent application No. 2006-085015 filed on Mar. 27, 2006, the entire contents of which are hereby incorporated by reference.

### BACKGROUND OF THE INVENTION

1. Field of the Invention

The present invention relates to an information processing device which includes a function of having multiple selectable items selected, and in particular, to the information processing device in which consideration is given to a method of managing selection history of the selection items and simplification of the selection.

2. Description of the Related Art

An information processing device includes a wide variety of functions and is capable of storing a wide variety of contents and files. However, there is a tendency that, the larger the number of them is, the more cumbersome an operation for a user becomes when selecting what the user desires from the large number of the functions and files. Conventional techniques relating to simplification of an operation for selecting a menu is disclosed in Japanese Patent Laid-Open Publication Nos. 7-129350, 9-128189, 10-269051, 2005-45719, and 2005-309618 (Patent Documents 1 to 5) and the like as those related to the techniques for simplifying the operation for selecting a selection item.

Conventionally, in the case where there are a large number of selection items, the selection items having a common attribute are grouped and the groups having the common attribute are further grouped to create a broader concept and perform a hierarchical grouping so as to improve management of each of the selection items and accessibility thereto. In addition, there is an adopted approach, such as preferentially displaying the selection item having a lot of selection history by managing selection frequency of each of the selection items.

As for the conventional method of managing the selection history of the selection items, however, it is basic that only pertinent selection frequency is increased in the case where the selection item is selected. Therefore, “a selection item having a lot of selection history in the past” is preferentially handled even if it is hardly selected lately, which was not able to effectively reflect recent usage of the user. In comparison, it is also possible to reflect the recent usage of the user by nullifying the selection history preceding by a certain period or more. However, “nullifying the selection history” also increased an adverse effect of nullifying an original function of “determining the user's taste by leaving the selection history.”

### SUMMARY OF THE INVENTION

In view of the above-mentioned points, an object of the present invention is to provide an information processing device which allows the user's recent usage to be reflected while leaving the user's usage history in the past and includes an item selection function with a simplified operation for selecting the selection item in terms of the method of managing the selection history of the selection item.

A first aspect provides an information processing device, comprising: an input portion; a storage portion; a control portion; and a selection screen display function, and wherein: the storage portion includes a selection history table having multiple selectable items and selection frequency information to be added on selecting each of the selection items correspondingly stored therein; and in the case where the selection screen display function is executed by a user's operation for the input portion, the selection item most frequently selected is obtained by referring to the selection history table to preferentially display or automatically select the obtained selection item; and in the case where it is determined that the selection item preferentially displayed has not been selected by the user or the selection item automatically selected has not been used, the selection history table is updated by relatively subtracting the selection frequency information corresponding to the selection item.

According to the configuration, in the case where, when the selection item most frequently selected is preferentially displayed or automatically selected, it is determined that the selection item has not been selected or has not been used by the user, the selection frequency information corresponding to the selection item is relatively subtracted. “To be preferentially displayed” means to be displayed at the top, to be displayed at a most easily selectable location according to a screen configuration and the like, to be highlighted in one way or another, and the like while displaying multiple selection items. “To relatively subtract the selection frequency information corresponding to the selection item” means to reduce frequency of use of an unselected (or unused) selection item in relativity with the entirety (other selection items), which is a concept including what relatively reduces the frequency of use of the unselected (or unused) selection item by adding the selection frequency information to all the other selection items.

A second aspect provides the information processing device according to the first aspect, wherein: when relatively subtracting the selection frequency information corresponding to the selection item preferentially displayed, the selection frequency of the selection item of which number of times of being selected is second to the highest is obtained by referring to the selection history table and the selection frequency information corresponding to the selection item preferentially displayed is relatively subtracted so as to be smaller than the second selection frequency.

According to the configuration, in the case where it is determined that the selection item is not selected or not used by the user when preferentially displayed or automatically selected, the selection frequency information corresponding to the selection item is relatively subtracted so that the number of times of being selected becomes smaller than the second.

A third aspect provides the information processing device according to the first or second aspect, wherein: when executing the process of relatively subtracting the selection frequency information, time information on execution of the process is correspondingly stored in the selection history table so that, when determined that there are multiple selection items most frequently selected in the process of obtaining the selection item most frequently selected, the selection item subtracted at the oldest time is obtained by referring to the selection history table.

According to the configuration, in the case where it is determined that there are multiple selection items most frequently selected in the process of obtaining the selection item most frequently selected, the selection item subtracted recently in comparison with the other selection items as to the selection frequency information is not obtained.

A fourth aspect provides the information processing device according to any one of the first to third aspects, wherein: the selection items are grouped according to an attribute belonging to each of the selection items; higher grouping is further performed according to the attribute belonging to each of the groups to hierarchically perform grouping; and when the selection screen display function is executed or when any one of the groups is selected during the execution of the selection screen display function, the selection item most frequently selected is obtained from all the selection items belonging to the selected group or lower groups of the selected group by referring to the selection history table so as to preferentially display or automatically select the obtained selection item.

According to the configuration, the selection item most frequently selected is obtained out of all the selection items belonging to the selected group (including the lower groups), which is preferentially displayed or automatically selected. As for the “higher grouping,” a higher group may also be created according to the attribute belonging to the selection items and the groups (the higher group is created by collecting the selection items and the groups) other than the case of creating the higher group according to the attribute mutually belonging to the groups (the higher group is created by collecting the lower groups).

A fifth aspect provides the information processing device according to any one of the first to third aspects, wherein: the selection items are grouped according to an attribute belonging to each of the selection items; higher grouping is further performed according to the attribute belonging to each of the groups to hierarchically perform grouping; and when the selection screen display function is executed or when any one of the groups is selected during the execution of the selection screen display function, the group most frequently selected in a current hierarchy is obtained by referring to the selection history table; the groups most frequently selected are sequentially obtained to the lowest group thereafter by referring to the selection history table so as to obtain the lowest group; and the selection item most frequently selected is obtained from the selection items belonging to the lowest group by referring to the selection history table so as to preferentially display or automatically select the obtained selection item.

According to the configuration, the groups most frequently selected from the selected groups are sequentially followed to obtain the lowest group, and the selection item most frequently selected is obtained from the selection items belonging to the lowest group to be preferentially displayed or automatically selected.

A sixth aspect provides the information processing device according to any one of the first to fifth aspects, wherein: an automatic selection key is provided to the input portion so as to execute the process of preferentially displaying or automatically selecting the selection item in the case where there is an input of the automatic selection key during the execution of the selection screen display function.

According to the configuration, the “aforementioned process of obtaining the selection item most frequently selected and preferentially displaying or automatically selecting the selection item” is executed by the input of the automatic selection key.

A seventh aspect provides the information processing device according to the sixth aspect, wherein: in the case where there is a further input of the automatic selection key when executing the process of preferentially displaying or automatically selecting the selection item, the selection items next most frequently selected are sequentially obtained by referring to the selection history table so as to execute the process of preferentially displaying or automatically selecting the obtained selection item.

According to the configuration, the second and third most frequently selected selection items are preferentially displayed or automatically selected in sequence when the “automatic selection key” is inputted for the second time and third time.

An eighth aspect provides a selection item priority giving program for causing the information processing device according to the first aspect to execute steps of: determining whether or not there is a request for execution of the selection screen display function; obtaining the selection item most frequently selected by referring to the selection history table in the case where there is the request for execution; preferentially displaying or automatically selecting the obtained selection item; determining whether or not the selection item preferentially displayed has been selected by the user or determining whether or not the selection item automatically selected has been used; and updating the selection history table by relatively subtracting the selection frequency information corresponding to the selection item in the case where it is determined that the selection item has been selected or used.

A ninth aspect provides a selection item priority giving method of an information processing device including a selection screen display function, wherein: selection frequency information which is added in relation to the selection item on selecting a selectable item is managed so that the selection item most frequently selected is obtained on execution of the selection screen display function to preferentially display or automatically select the obtained selection item; and in the case where it is determined that the selection item preferentially displayed has not been selected by the user or the selection item automatically selected has not been used, the selection frequency information corresponding to the selection item is relatively subtracted.

### BRIEF DESCRIPTION OF THE DRAWINGS

FIG. 1 is a block diagram showing an overview only of a portion mainly related to the present invention of a DVD reproducing device;

FIG. 2 is a diagram showing an example of a configuration of a selection history table;

FIG. 3 is a flowchart showing an overview of an operation of the portion mainly related to the present invention as to a process of changing setups of various functions of the DVD reproducing device ;

FIG. 4 is a diagram showing an example of a display screen (setup screen);

FIG. 5 is a diagram showing an example of the display screen (main menu screen);

FIG. 6 is a flowchart showing an overview of the operation of the portion mainly related to the present invention as to another process of changing the setups of various functions of the DVD reproducing device;

FIG. 7 is a block diagram showing an overview only of the portion mainly related to the present invention of an LCD TV;

FIG. 8 is a diagram showing an example of a configuration of a setup item grouping table;

FIG. 9 is a diagram showing a hierarchical structure of a menu;

FIG. 10 is a flowchart showing an overview of the operation of the portion mainly related to the present invention as to a process of changing the setups of various functions of the LCD TV;

FIG. 11 is a flowchart showing an overview of the operation of a setup item selection process;

FIG. 12 is a diagram showing another example of the display screen (main menu screen); and

FIGS. 13A, B and C are diagrams showing an example of the display screen (pull-down menu screen).

### DETAILED DESCRIPTION OF THE PREFERRED EMBODIMENTS

Hereunder, concrete embodiments of the present invention will be described with reference to the drawings. The following embodiments are forms for embodying the present invention, which are not intended to limit the present invention within the scope thereof.

### First Embodiment

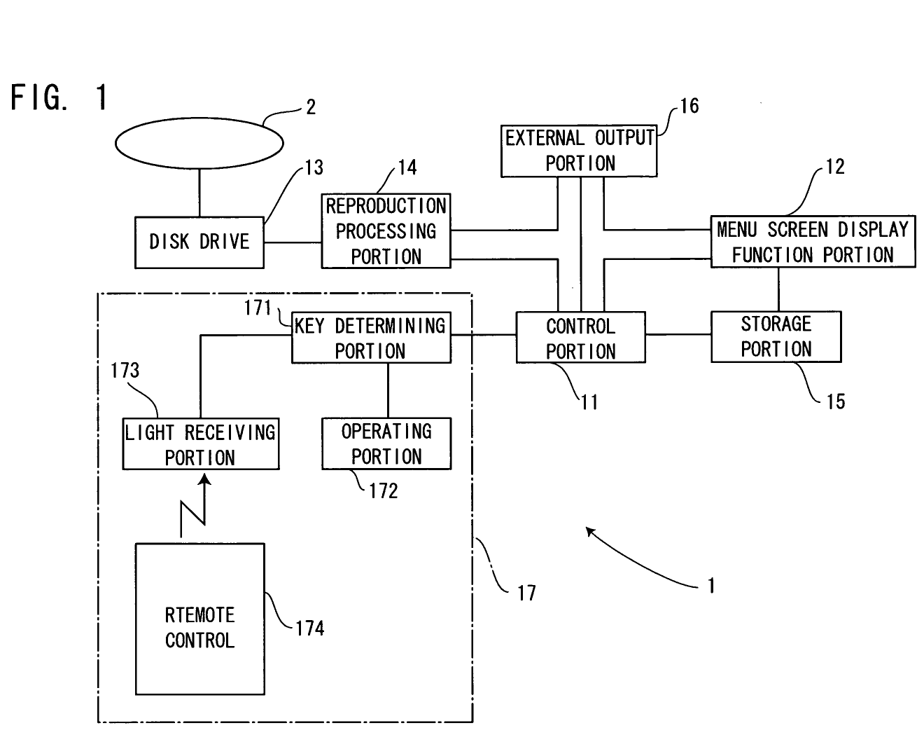

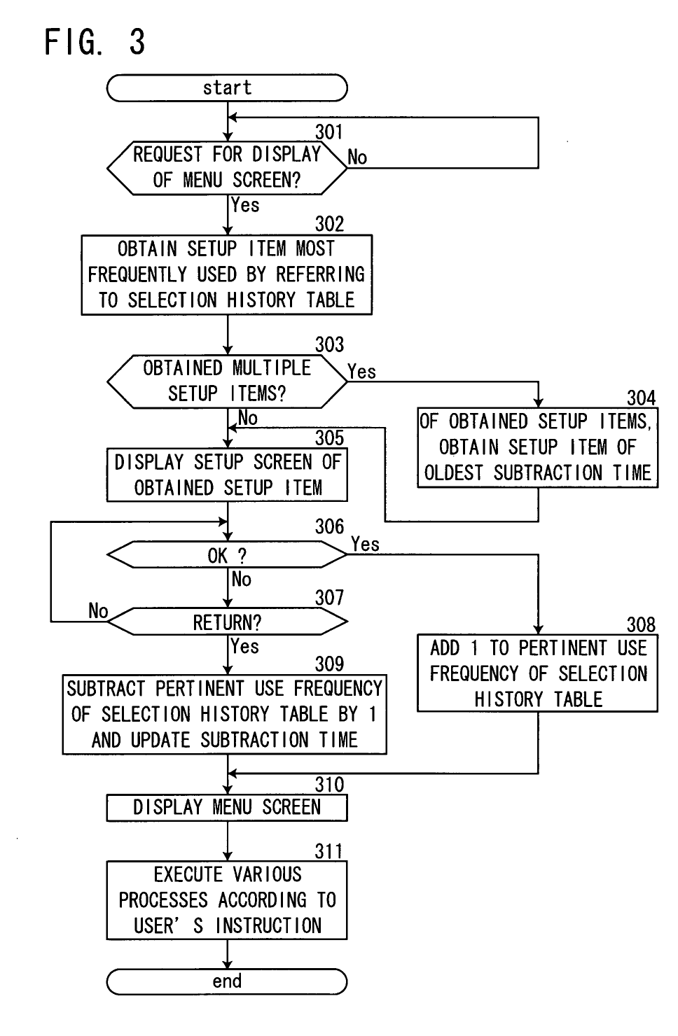

FIG. 1 is a block diagram showing an overview only of a portion mainly related to the present invention of a DVD reproducing device (an example of an information processing device) of this embodiment. FIG. 3 is a flowchart showing an overview of an operation of the portion related to the present invention of the DVD reproducing device.

As shown in FIG. 1, a DVD reproducing device 1 of this embodiment includes a control portion 11 for controlling the entire device and performing various kinds of arithmetic processing and the like, a menu screen display function portion 12 for executing a display process of a menu screen (selection screen display function) for setting up various functions and the like of the DVD reproducing device 1, a storage portion 15 which is storage means, a disk drive 13 for reading a signal from a DVD 2 which is an information recording medium, a reproduction processing portion 14 for reproducing the contents recorded on the DVD 2 by including a decoder or the like for extending data inputted from the disk drive 13, an external output portion 16 for outputting video/audio signals generated by the reproduction processing portion 14 to an external display device (such as a TV), an input portion 17 (composed of a body operating portion 172, a remote control device 174, a light receiving portion 173 for receiving a signal from the remote control device 174, a key determining portion 171 for determining and outputting a signal from the body operating portion 172 or the light receiving portion 173) which is an input interface to a user, and the like.

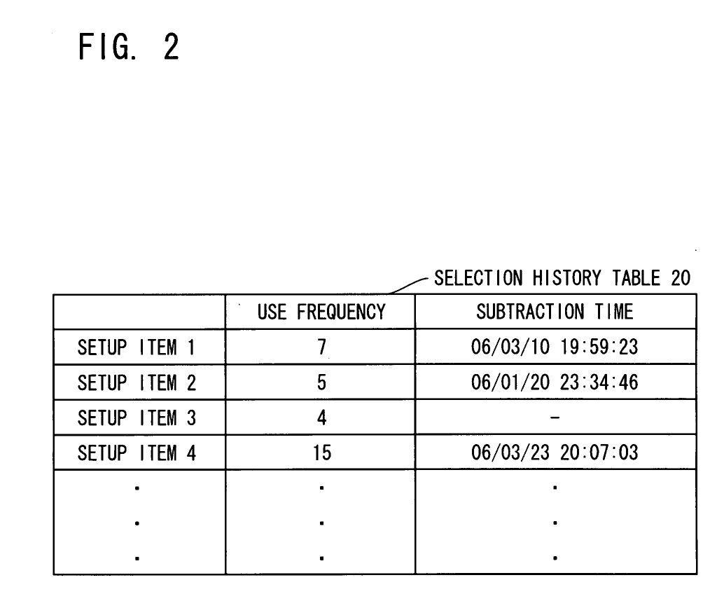

The storage portion 15 has a selection history table shown in FIG. 2 stored therein. In the case where each individual setup item is used, use frequency (selection frequency information) is added and stored.

FIG. 3 is a flowchart showing an overview of the operation of the portion related to the present invention of the DVD reproducing device 1 as to the process of changing the setups of various functions.

In a step 301, it waits for a request for displaying the menu screen by the user's operation of the input portion 17 (request for execution of the function of changing the setups of various functions). In the case where there is the request, the setup item most frequently used is obtained by referring to a selection history table 20 which is stored in the storage portion 15 by the menu screen display function portion 12 (or the control portion 11) (step 302). In a subsequent step 303, it is determined whether or not there are multiple “setup items most frequently used.” In the case where there are multiple setup items most frequently used, it moves on to a step 304. In the step 304, it obtains the setup item of which subtraction time (time information stored in the selection history table 20 by a step 309 described below) is the oldest out of the “setup items most frequently used” by referring to the selection history table 20.

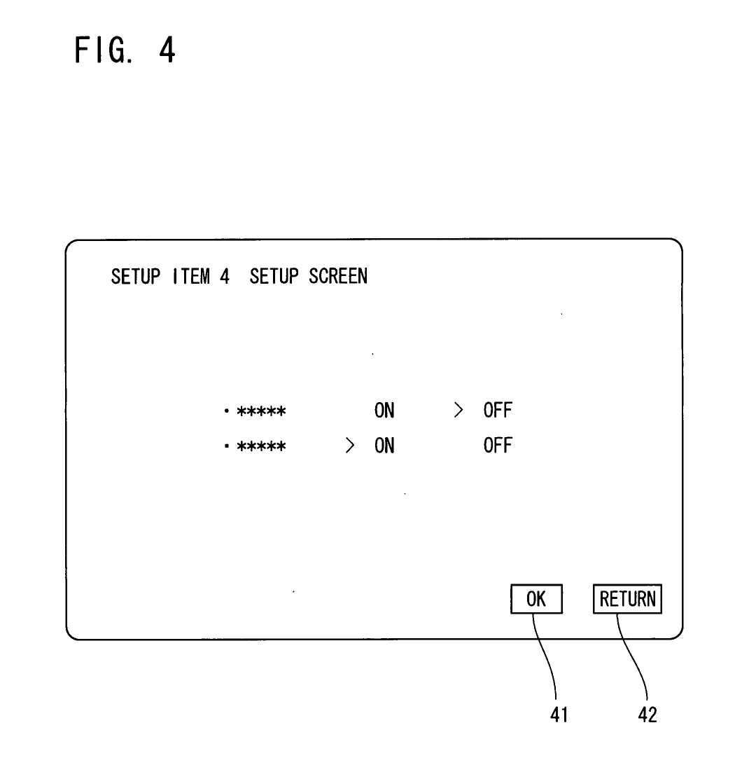

In a step 305 when one “setup item most frequently used” is obtained in the step 303 or after obtaining the setup item in the step 304, the display process of a setup screen of the obtained setup item (FIG. 4 shows an example of the setup screen) is performed. The “display process of the screen” means to generate an OSD signal of the screen shown in FIG. 4 by means of the menu screen display function portion 12 and output it from the external output portion 16 so as to display it on the display device (such as a TV) connected to the DVD reproducing device 1 (a screen display process below is the same concept).

In loop processing of steps 306 to 307, it waits for an input of an OK button 41 or a return button 42. In the case where there is the input of the OK button 41 (in the case where there is an instruction to change the setup item for instance and reflect it on the device) (step 306), the change of the setup is set on the device and the corresponding use frequency of the selection history table 20 is incremented (step 308).

In the case where there is the input of the return button 42 (in the case where no change has been made to the setup item and in the case where it is determined that the displayed setup item has not been used) (step 307), the corresponding use frequency of the selection history table 20 is decremented and a current time (information obtained by a clock function provided to the control portion 11) is stored in the selection history table 20 as subtraction time (step 309).

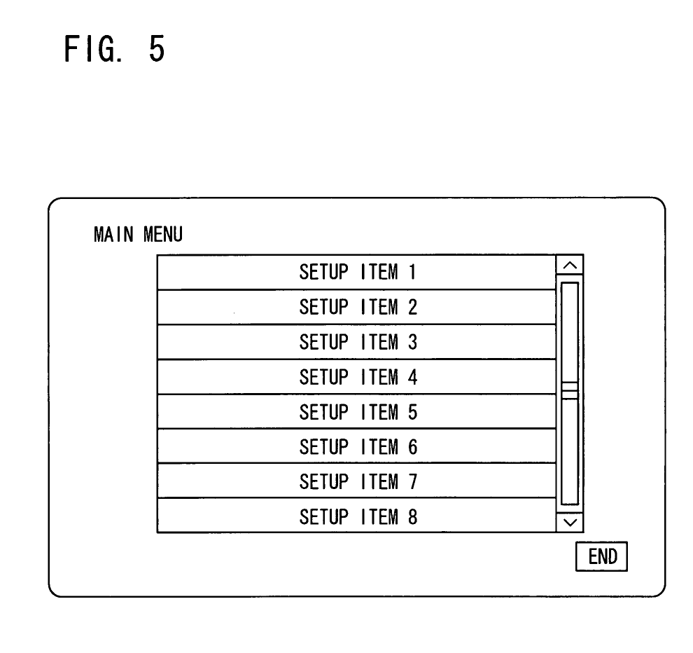

In a subsequent step 310, it displays a main menu screen as shown in FIG. 5 and executes a process according to the user's instruction to the screen (step 311) to finish the process. The steps 310 to 311 are a so-called normal “process for changing the setups of various functions (for instance, the screen shown in FIG. 4 is displayed in the case where a “setup item 4” in the menu of FIG. 5 is selected).” According to the present invention, the process of the steps 302 to 309 is executed when there is a request for execution of the “process for changing the setups of various functions” (request for displaying the menu screen) (step 301). In the conventional process, however, the process of the step 310 (displaying the main menu) is performed immediately after the step 301.

As described above, according to the DVD reproducing device 1 of this embodiment, the setup item (selection item) most frequently selected is automatically selected and the use frequency corresponding to the setup item is subtracted in the case where it is determined that the setup item has not been used by the user. Therefore, it is possible to reflect the user's recent usage while using the user's usage history in the past. To be more specific, in the case where a setup item 3 has the usage history of being used 100 times in the past for instance in the conventional instance of “managing the usage history just by addition and preferentially selecting (displaying) the one most frequently used,” the setup item 3 continues to be preferentially selected (displayed) even if it has been hardly used recently until the history of another setup item exceeds 100. According to this embodiment, however, the history is rapidly subtracted if the preferentially selected (displayed) setup item 3 continues to be unused so that it is possible to “reflect the user's recent usage.” In the case of “reflecting the user's recent usage” by “nullifying the selection history preceding by a certain period or more,” there is a possibility that, depending on a condition such as the setup of “a certain period,” the usage history may be rendered as 0 times even though there is the history of being used 100 times in the past (there is an equivalent record of use). According to this embodiment, however, the equivalent record of use in the past is also reflected if any. Therefore, it is possible to “reflect the user's recent usage as well as the user's usage history in the past.”

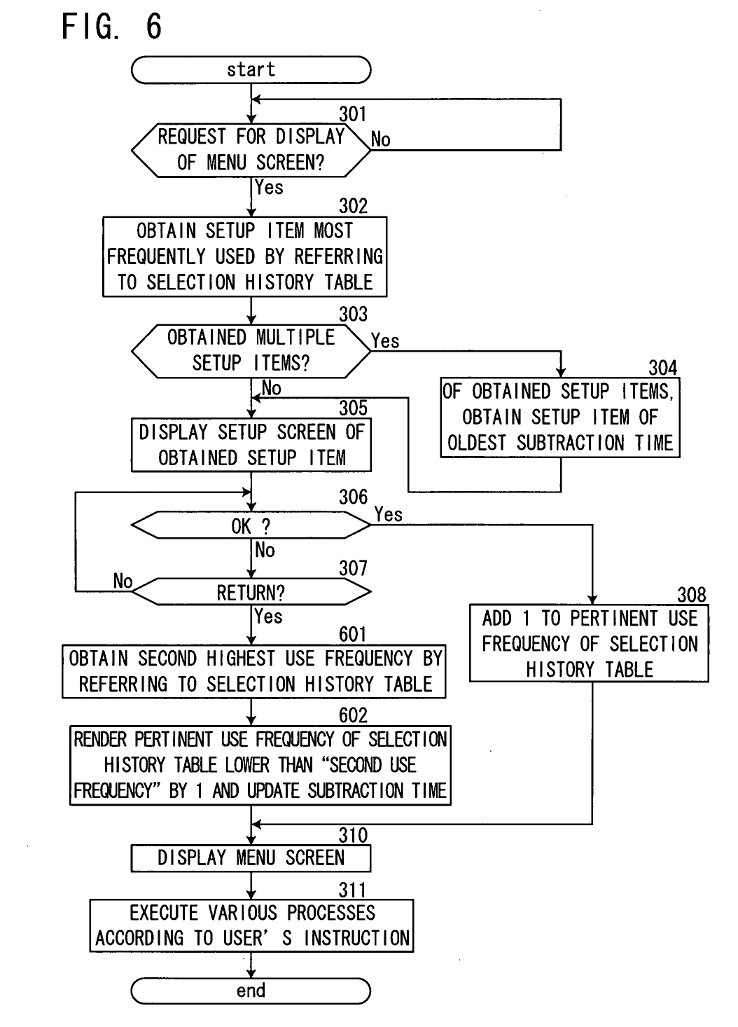

According to this embodiment, an amount of the use frequency to be subtracted is 1. However, 2 or more may also be subtracted or the amount to be subtracted may be increased instead of subtracting a fixed value if determined to be continuously unused for instance (it is also possible to relatively subtract the use frequency of an unused (or unselected) item by adding the use frequency of all the other items rather than directly subtracting the use frequency of the unused (or unselected) item). It is also possible to perform subtraction so that the use frequency becomes the second or below. FIG. 6 shows a flowchart of a process in which the use frequency becomes the second (the second or below as the case may be) when subtracting the use frequency. The same steps as those of FIG. 3 are given the same symbols.

In the case where there is the input of the return button 42 (step 307), the use frequency second to the highest is obtained by referring to the selection history table 20 (step 601), and the pertinent use frequency (of the selection item automatically selected in the step 305) is updated by reducing the “use frequency second to the highest” by 1 (step 602). In the case where it is determined by the above process that the selection item automatically selected has not been used, the use frequency becomes the second (the second or below in the case where there are multiple selection items of the “use frequency second to the highest”) so that it will no longer be “the selection item automatically selected” when executing this process next (because it will no longer be selected in the process of the step 302).

In the case where one selection item cannot be selected from the “setup items most frequently used” because the “setup items most frequently used” have no subtraction time (the use frequency has not been subtracted) for instance in the process of the step 304, one “setup item most frequently used” should be selected by following default priorities (display order on the main menu screen) for instance.

This embodiment described the process of selecting the setup items of the DVD reproducing device as an application example of the present invention. However, the applicable scope of the present invention is not limited to “menu selection” and the like. It is also applicable to the process of selecting a conversion candidate of character conversion in the information processing device such as a personal computer.

### Second Embodiment

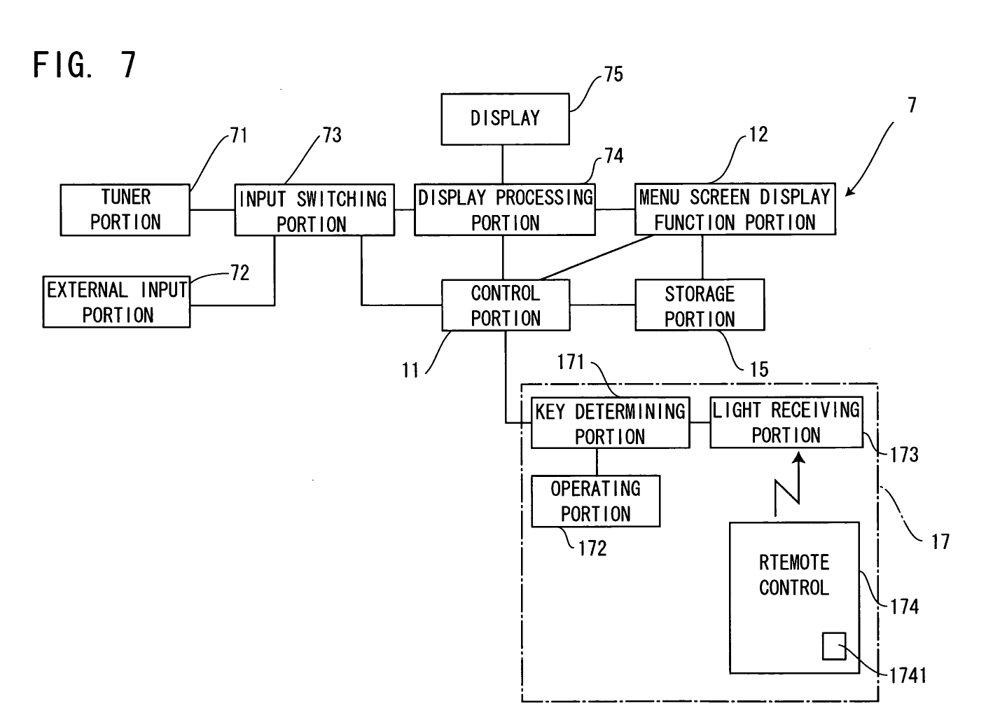

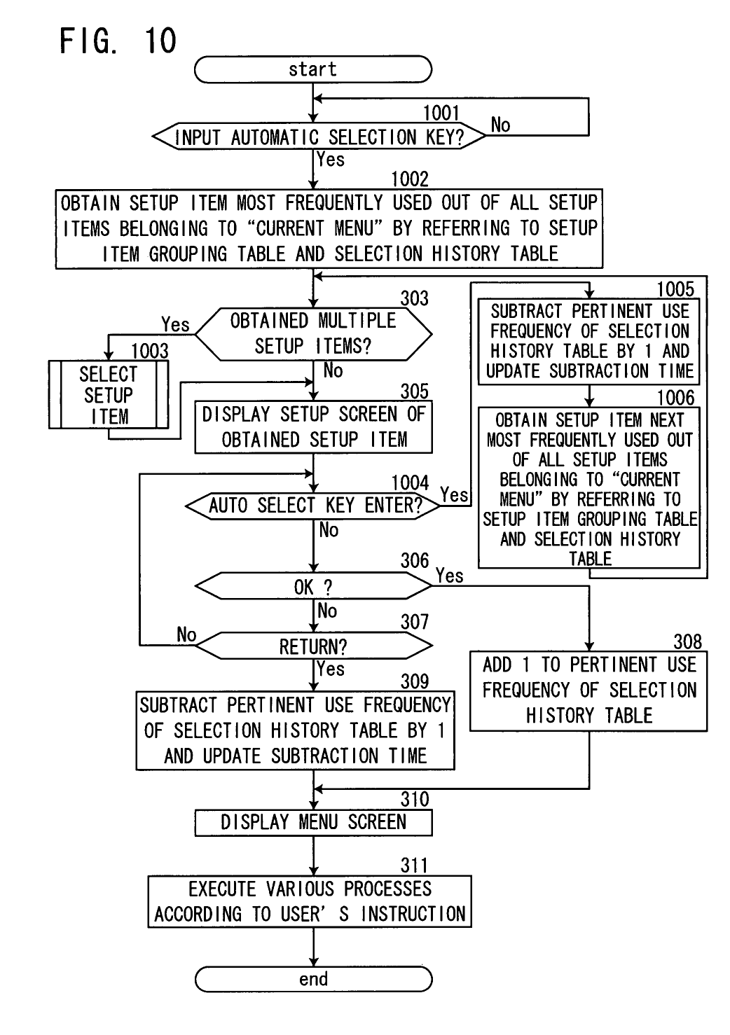

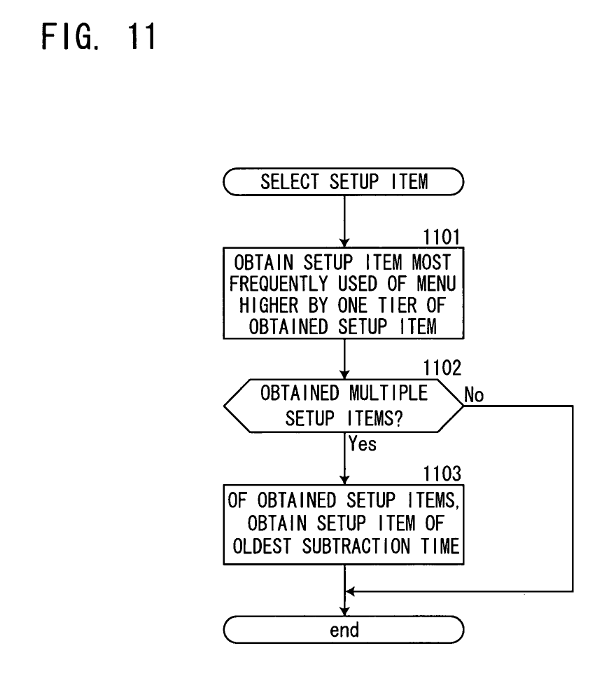

FIG. 7 is a block diagram showing an overview only of the portion related to the present invention of an LCD TV of this embodiment. The same components as the first embodiment are given the same symbols as those of the first embodiment (FIG. 1), and a description thereof will be omitted or simplified here. FIGS. 10 and 11 are flowcharts showing an overview of the operation of the portion related to the present invention of the LCD TV.

As shown in FIG. 7, as with the DVD reproducing device 1 of the first embodiment, an LCD TV 7 of this embodiment includes a control portion 11, a menu screen display function portion 12, a storage portion 15 and an input portion 17, and also includes a display portion 75 for displaying video, a tuner portion 71 for receiving a broadcast signal, an external input portion 72 for inputting video/audio signals from an external device (such as an HDD recorder), an input switching portion 73 for switching and outputting a signal from the tuner portion 71 or the external input portion 72, a display processing portion 74 for displaying the video signal inputted from the input switching portion 73 or the like on a display 75.

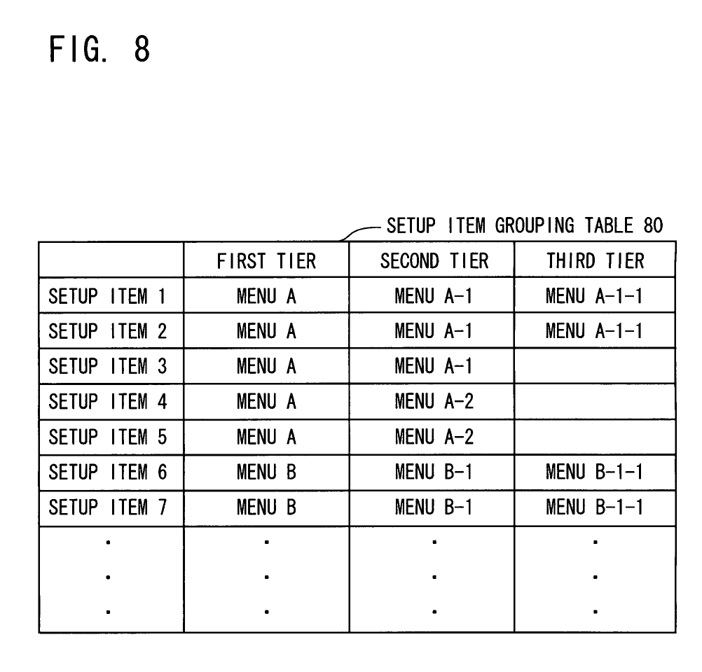

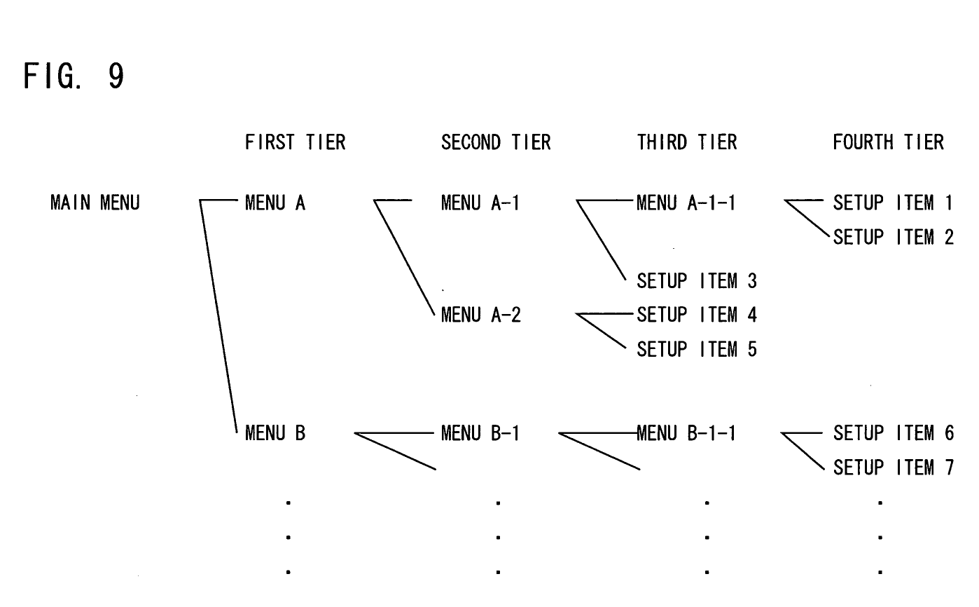

The storage portion 15 has a selection history table 20 (FIG. 2) stored therein as with the first embodiment. In the case where each individual setup item is used, the use frequency (selection frequency information) is added and stored therein. As shown in FIG. 9, the setup items of this embodiment are grouped according to an attribute belonging to each of the selection items, and higher grouping is further performed according to the attribute belonging to each of the groups so as to be hierarchical. The setup of the grouped structure is stored in a setup item grouping table 80 as shown in FIG. 8 and is also stored in the storage portion 15. Thus, a menu of a first hierarchy (such as a menu A or a menu B) is displayed on the main menu screen. In the case where the menu A is selected here for instance, a menu A-1 and a menu A-2 of a second hierarchy are displayed. In the case where the menu A-1 is further selected here, a menu A-1-1 and the setup item 3 are displayed. In the case where the menu A-1-1 is selected here, it moves on to a fourth hierarchy (setup items 1 and 2). In the case where the setup item 3 is selected here, it moves on to the setup screen of the setup item 3 (same screen as FIG. 4).

FIG. 10 is a flowchart showing an overview of the operation of the portion mainly related to the present invention of the LCD TV 7 as to the process of changing the setups of various functions thereof. This process is executed when there is an input of an “automatic selection key 1741” (request for execution of a selection item automatic selection function related to the present invention) of the remote control device 174 in the process of changing the setups of various functions (process of displaying the menu of the setup items) of the LCD TV 7. The same process concepts as the first embodiment (FIG. 3) are given the same symbols as those of the first embodiment, and a description thereof will be omitted or simplified here.

In a step 1001, it is determined whether or not there is the user's input of the automatic selection key 1741 of the input portion 17 (remote control device 174). In the case where there is the input, the setup item most frequently used is obtained out of all the setup items belonging to the “current menu” by referring to the selection history table 20 and the setup item grouping table 80 stored in the storage portion 15 by the menu screen display function portion 12 (or the control portion 11) (step 1002). As for the process, in the case where there is the input of the automatic selection key 1741 with the main menu displayed for instance, the “current menu” becomes the main menu so that the setup item most frequently used is obtained out of all the setup items. In the case where there is the input of the automatic selection key 1741 with the menu A displayed, the “current menu” becomes the menu A so that the setup item most frequently used is obtained out of all the setup items belonging to the menu A (setup items 1 to 5 in the case of FIG. 9). In a step 1002, the “current menu” is maintained (temporarily stored in the storage portion 15) until this process (process in FIG. 10) is finished.

In the step 303 following the step 1002, it is determined whether or not multiple setup items were obtained in the step 1002. In the case of multiple setup items, it moves on to a “setup item selection process” of a step 1003.

FIG. 11 is a flowchart showing an overview of the operation of the “setup item selection process” executed in the step 1003 of FIG. 10. In a step 1101, the use frequency of the menu higher by one tier of each setup item obtained in the step 1002 (FIG. 10) is calculated by referring to the selection history table 20 and the setup item grouping table 80 so as to obtain the setup item of the highest use frequency. As for the “use frequency of the menu higher by one tier of each setup item,” in the case of a setup item 2 for instance, the menu higher by one tier is the menu A-1-1 of which use frequency is obtained by summing up the use frequency of all the setup items belonging to the menu A-1-1 (setup items 1 and 2 in the case of FIG. 9). It is also possible to obtain an average of the use frequency instead of summing up the use frequency of the setup items. It is further possible to manage the sum and average correspondingly to each of the menus as history instead of calculating the sum and average each time.

In a subsequent step 1102, it is determined whether or not multiple setup items have been obtained in the step 1101. In the case of multiple setup items, the setup item subtracted at the oldest time is obtained by referring to the selection history table 20 in a step 1103 (the same process concepts as the step 304 of the first embodiment (FIG. 3)).

The description will be continued by returning to FIG. 10. In the step 305, the setup screen (the same screen as FIG. 4) of the setup item obtained by the “setup item selection process” (step 1003) is displayed, and it waits for the input of any one of the “automatic selection key 1741,” “OK button 41” and “return button 42” in the loop of the subsequent steps 1004 to 307. In the case where there is the input of the “OK button 41” or the “return button 42” (step 306 or 307), the process of the steps 308 to 311 (the same process concept as the first embodiment (FIG. 3)) is executed. The display process of the menu screen in the step 310 may be either the process of displaying the main menu screen or the process of displaying the menu screen of the “current menu” temporarily stored in the step 1002.

In the case where there is the input of the “automatic selection key 1741” again in the loop of the steps 1004 to 307, it moves on to a step 1005 (step 1004). In the step 1005, the corresponding (corresponding to the setup item of which setup screen is displayed by the step 305) use frequency of the selection history table 20 is decremented and the current time is stored in the selection history table 20 as the subtraction time. In a subsequent step 1006, the setup item next most frequently used (the setup item next most frequently used following the setup item of which setup screen is displayed by the step 305) is obtained out of all the setup items belonging to the “current menu” temporarily stored in the step 1002 (the menu temporarily stored in the step 1002) by referring to the selection history table 20 and the setup item grouping table 80.

After the step 1006, it moves on to the step 303 and repeats the above process thereafter so that the second and third most frequently used setup items are automatically selected in sequence when the “automatic selection key 1741” is inputted for the second time and third time (in this case, the use frequency of the setup item determined to be unused is subtracted)

As described above, according to the LCD TV 7 of this embodiment, the setup item most frequently used is obtained out of all the setup items (selection items) belonging to the selected menus (groups) (including the lower groups), which is automatically selected. Therefore, it is possible to select the setup items by a simple operation, where the selection operation is apt to become cumbersome otherwise because the hierarchy is deep. Furthermore, the second and third most frequently used setup items are automatically selected in sequence when the “automatic selection key” is inputted for the second time and third time. Therefore, it is possible to select the setup items of higher use frequency by a simple operation.

According to this embodiment, “the setup item most frequently used is obtained out of all the setup items belonging to the “current menu”” in the process of obtaining the setup item in the step 1002 and the like. However, it may also be the process in which “the menus most frequently used out of the menus belonging to each of the menus are sequentially followed to obtain the lowest menu, and the setup item most frequently used is obtained out of the setup items belonging to the lowest menu.” To be more specific, it may also be the following process. In the case where the “current menu” is the menu A (FIG. 9) for instance, the menu more frequently used is obtained out of the menu A-1 and menu A-2. In the case where it is the menu A-2, it is the lowest menu since there is no menu below the menu A-2. It may be the process of obtaining the setup item most frequently used out of the setup items belonging to the lowest menu A-2 (setup items 4 and 5).

The embodiment describes as if the menu screen display function portion 12 is configured as hardware. However, it may also be configured software-wise by a program stored in the storage portion (configured by a program and a microcontroller for executing it).

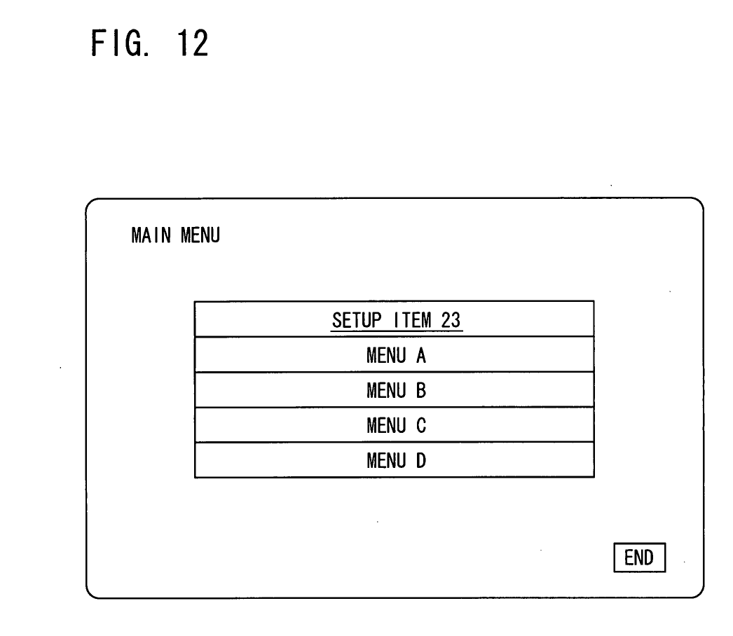

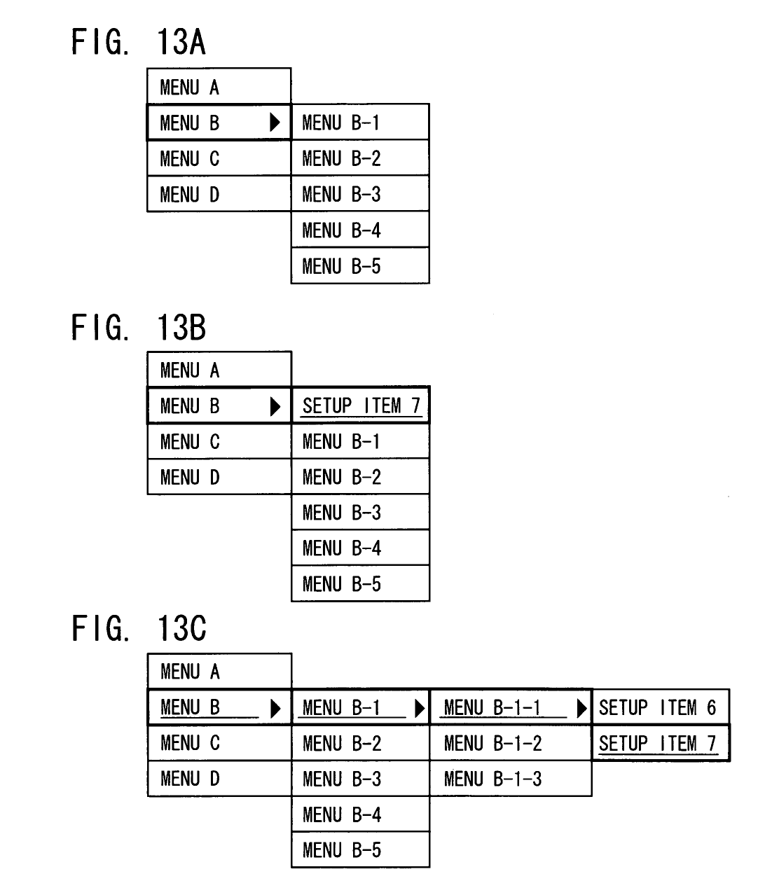

The embodiment was described by taking what “automatically selects the setup item” (what automatically displays the setup screen of the setup item obtained according to a predetermined condition) as an example. However, it may also be what “preferentially displays” instead of what “automatically selects.” To “preferentially display” means to display it at the top, display it at a most easily selectable location according to a screen configuration and the like, highlight it in one way or another, and the like while multiple selection items are displayed. For instance, as shown in FIG. 12, a “setup item 23” which is an item not originally displayed (its tier is not a first tier) is preferentially displayed on the main menu screen. Also, as shown in FIGS. 13A, B, and C, while it is normally a pull-down menu display as shown in FIG. 13A (a menu B is selected), a setup item 7 which is most frequently used is preferentially displayed out of the setup items belonging to the menu B by having the “automatic selection key” inputted or the like as shown in FIGS. 13B and 13C. In the case where it is determined that the item thus preferentially displayed has not been selected, the use frequency of the setup item is subtracted.

The embodiment gave a description by taking the “menu selection” of the DVD reproducing device and the LCD TV as an example. The present invention is also effectively applicable to a selection process of files and the like which are hierarchically managed, not to mention the “menu selection” of various information processing devices such as a personal computer and a cell-phone.

The effects of the present invention are as follows.

The information processing device according to the first aspect of the present invention is the one comprising: an input portion; a storage portion; a control portion; and a selection screen display function, and wherein the storage portion includes a selection history table having multiple selectable items and selection frequency information to be added on selecting each of the selection items correspondingly stored therein; and in the case where the selection screen display function is executed by a user's operation for the input portion, the selection item most frequently selected is obtained by referring to the selection history table to preferentially display or automatically select the obtained selection item; and in the case where it is determined that the selection item preferentially displayed has not been selected by the user or the selection item automatically selected has not been used, the selection history table is updated by relatively subtracting the selection frequency information corresponding to the selection item. According to the information processing device, in the case where it is determined that when the selection item most frequently selected is preferentially displayed or automatically selected, the selection item is not selected or not used by the user, the selection frequency information corresponding to the selection item is relatively subtracted so that it is possible to reflect the user's recent usage while using the user's usage history in the past. To be more specific, the user's recent usage is not reflected by “nullifying the selection history preceding by a certain period or more” or the like but it is reflected by using and preferentially displaying the user's usage history in the past while relatively subtracting the selection history of the selection item in the case where the selection item is not selected.

The information processing device according to the fourth aspect of the present invention is the one according to any one of the first to third aspects, wherein: the selection items are grouped according to an attribute belonging to each of the selection items; higher grouping is further performed according to the attribute belonging to each of the groups to hierarchically perform grouping; and when the selection screen display function is executed or when any one of the groups is selected during the execution of the selection screen display function, the selection item most frequently selected is obtained from all the selection items belonging to the selected group or lower groups of the selected group by referring to the selection history table so as to preferentially display or automatically select the obtained selection item. According to the information processing device, the selection item most frequently selected is obtained from all the selection items belonging to the selected groups (including the lower groups), which is preferentially displayed or automatically selected. Therefore, it is possible to select the selection items by a simple operation, where selection operation is apt to become cumbersome otherwise because the hierarchy is deep.

The information processing device according to the seventh aspect of the present invention is the one according to the sixth aspect, wherein: in the case where there is a further input of the automatic selection key when executing the process of preferentially displaying or automatically selecting the selection item, the selection items next most frequently selected are sequentially obtained by referring to the selection history table so as to execute the process of preferentially displaying or automatically selecting the obtained selection item. According to the information processing device, the second and third most frequently selected selection items are preferentially displayed or automatically selected in sequence when the “automatic selection key” is inputted for the second time and third time. Therefore, it is possible to select the selection items frequently used by a simple operation.

1. An information processing device, comprising:
an input portion;
a storage portion;
a control portion; and
a selection screen display function, and wherein:
the storage portion includes a selection history table having multiple selectable items and selection frequency information to be added on selecting each of the selection items correspondingly stored therein; and
in the case where the selection screen display function is executed by a user's operation for the input portion, the selection item most frequently selected is obtained by referring to the selection history table to preferentially display or automatically select the obtained selection item; and
in the case where it is determined that the selection item preferentially displayed has not been selected by the user or the selection item automatically selected has not been used, the selection history table is updated by relatively subtracting the selection frequency information corresponding to the selection item.

2. The information processing device according to claim 1, wherein:
when relatively subtracting the selection frequency information corresponding to the selection item preferentially displayed, the selection frequency of the selection item of which number of times of being selected is second to the highest is obtained by referring to the selection history table and the selection frequency information corresponding to the selection item preferentially displayed is relatively subtracted so as to be smaller than the second selection frequency.

3. The information processing device according to claim 1, wherein:
when executing the process of relatively subtracting the selection frequency information, time information on execution of the process is correspondingly stored in the selection history table so that, when determined that there are multiple selection items most frequently selected in the process of obtaining the selection item most frequently selected, the selection item subtracted at the oldest time is obtained by referring to the selection history table.

4. The information processing device according to claim 1, wherein:
the selection items are grouped according to an attribute belonging to each of the selection items;
higher grouping is further performed according to the attribute belonging to each of the groups to hierarchically perform grouping; and
when the selection screen display function is executed or when any one of the groups is selected during the execution of the selection screen display function, the selection item most frequently selected is obtained from all the selection items belonging to the selected group or lower groups of the selected group by referring to the selection history table so as to preferentially display or automatically select the obtained selection item.

5. The information processing device according to claim 1, wherein:
the selection items are grouped according to an attribute belonging to each of the selection items;
higher grouping is further performed according to the attribute belonging to each of the groups to hierarchically perform grouping; and
when the selection screen display function is executed or when any one of the groups is selected during the execution of the selection screen display function, the group most frequently selected in a current hierarchy is obtained by referring to the selection history table;
the groups most frequently selected are sequentially obtained to the lowest group thereafter by referring to the selection history table so as to obtain the lowest group; and
the selection item most frequently selected is obtained from the selection items belonging to the lowest group by referring to the selection history table so as to preferentially display or automatically select the obtained selection item.

6. The information processing device according to claim 1, wherein:
an automatic selection key is provided to the input portion so as to execute the process of preferentially displaying or automatically selecting the selection item in the case where there is an input of the automatic selection key during the execution of the selection screen display function.

7. The information processing device according to claim 6, wherein:
in the case where there is a further input of the automatic selection key when executing the process of preferentially displaying or automatically selecting the selection item, the selection items next most frequently selected are sequentially obtained by referring to the selection history table so as to execute the process of preferentially displaying or automatically selecting the obtained selection item.

8. A selection item priority giving program for causing the information processing device according to claim 1 to execute steps of:
determining whether or not there is a request for execution of the selection screen display function;
obtaining the selection item most frequently selected by referring to the selection history table in the case where there is the request for execution;
preferentially displaying or automatically selecting the obtained selection item;
determining whether or not the selection item preferentially displayed has been selected by the user or determining whether or not the selection item automatically selected has been used; and
updating the selection history table by relatively subtracting the selection frequency information corresponding to the selection item in the case where it is determined that the selection item has been selected or used.

9. A selection item priority giving method of an information processing device including a selection screen display function, wherein:
selection frequency information which is added in relation to the selection item on selecting a selectable item is managed so that the selection item most frequently selected is obtained on execution of the selection screen display function to preferentially display or automatically select the obtained selection item; and
in the case where it is determined that the selection item preferentially displayed has not been selected by the user or the selection item automatically selected has not been used, the selection frequency information corresponding to the selection item is relatively subtracted.
